(19) United States
(12) Patent Application Publication
(10) Pub. No.: US 2013/0260752 A1
(43) Pub. Date: Oct. 3, 2013

(54) SYSTEM AND METHODS FOR DYNAMICALLY CONFIGURIG CELL SEARCH WINDOW FOR PILOT ACQUISITION

(71) Applicants: Bhaskara V. Batchu, Ameenpur Village (IN); Anand Rajurkar, Hyderabad (IN); Aditya Bohra, Hyderabad (IN); Karthik P.K. Bhogaraju, Hyderabad (IN)

(72) Inventors: Bhaskara V. Batchu, Ameenpur Village (IN); Anand Rajurkar, Hyderabad (IN); Aditya Bohra, Hyderabad (IN); Karthik P.K. Bhogaraju, Hyderabad (IN)

(73) Assignee: Qualcomm Incorporated, San Diego, CA (US)

(21) Appl. No.: 13/605,617

(22) Filed: Sep. 6, 2012

Related U.S. Application Data
(60) Provisional application No. 61/618,205, filed on Mar. 30, 2012.

(51) Int. Cl. H04W 48/16

(52) U.S. Cl. CPC H04W 48/16
USPC 455/434

(57) ABSTRACT

Systems, methods, and computer program products for dynamically selecting cell search parameters by a mobile device are discussed. In one aspect, a mobile device first acquires a first radio access network (RAN) cell using a first search window associated with the first RAN cell, and then determines to acquire a second RAN cell operating at least in part in the same region as the first RAN cell. The mobile device then selects a second search window for acquiring the second RAN cell. Particularly, mobile device determines if a pilot spacing parameter for the second RAN cell is known. If the pilot spacing parameter is known, the mobile device computes the second search window as a function of the pilot spacing parameter. If the pilot spacing parameter is unknown, the mobile device selects a default value for the second search window. Other aspects, embodiments, and features are also claimed and described.

### CROSS REFERENCE TO RELATED APPLICATION & PRIORITY CLAIM

This patent application is related to and claims the priority benefit to U.S. Provisional Application No. 61/618,205, filed 30 Mar. 2012, which is hereby incorporated by reference herein as if fully set forth below and for all applicable purposes.

### TECHNICAL FIELD

This disclosure relates generally to the field of communications and more specifically to systems and methods for preventing system losses in cell overlap regions. In some aspects and embodiments, this can be done by dynamically configuring cell search window for pilot acquisition.

### BACKGROUND

Wireless communication networks are widely deployed to provide various communication services such as telephony, video, data, messaging, broadcasts, and so on to mobile devices, also known as user equipment (UE). Such networks, which are usually multiple access networks, support communications for multiple users by sharing the available network resources.

One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Signal transmissions in CDMA networks are subject to multipath propagation. Multipath is the propagation phenomenon that results in the radio signals reaching the receiving antenna by two or more paths. Causes of multipath may include atmospheric ducting, ionospheric reflection and refraction, and reflection from water bodies and terrestrial objects such as mountains and buildings. Depending on the terrain (rural, urban, etc.), a UE may receive signals via multiple signals paths each of which may be either delayed or early in time relative to each other. When a UE is operating in a RAN cell, it uses specific search parameters as configured by the RAN base station in order to latch on (or reacquire) a pilot signal from the base station. One of these parameters is a search window, which is a time range in which the searcher engine of the UE searches for the pilot signals (PN) form base station. The search window is typically centered around the earliest usable multipath component for pilot signal from the serving base station.

In some cases, however, a moving UE may find itself within coverage of two or more neighboring cells. In these overlap regions, a UE may see strong signal paths from two or more neighboring cells. In a scenario where a first arriving pilot path from serving cell_1 is the ‘early’ path, the receiver of the UE will lock to the ‘early path’ of cell_1 using search parameters of cell_1. However, due to, for example, overload in cell_1 or as per standard recommendation, cell_1 may instruct UE to try to switch (or handoff) to a neighbor cell_2 or different sector of cell_1. If the first arriving path from cell_2 is a delayed path, the presently configured active search parameters for cell_1, e.g., search window, may not be sufficient to lock on to the cell_2, due to the large difference in timings of the two cells. This forces the UE to go back and try to reacquire cell_1, but cell_1 may again redirect the UE to handoff to cell_2 and this process repeats. This ping-pong effect causes a system loss as UE does not get locked to any of these cells, can degrade UE power resources, and can cause negative user experience. Accordingly, there is a need for method for dynamically configuring cell search parameters for pilot acquisition in order to prevent system losses in cell overlap regions.

### BRIEF SUMMARY OF SOME EMBODIMENTS

To address the issues mentioned above and others, disclosed herein are system, methods and computer program products for dynamically configuring cell search window for pilot acquisition in order to prevent system losses in cell overlap regions. Generally, a UE may be configured to acquire a first radio access network (RAN) cell using a first search window associated with the first RAN cell. When the UE determines to acquire a second RAN cell operating at least in part in the same region as the first RAN cell, the UE selects a second search window for acquiring the second RAN cell. For example, the UE can determine if a pilot spacing parameter for the second RAN cell is known. If the pilot spacing parameter is known, the UE computes the second search window as a function of the pilot spacing parameter. If the pilot spacing parameter is unknown, the UE selects a default value for the second search window. The UE can then acquire the second RAN cell using the selected second search window. After acquisition of the second cell, the UE may update second search window based on information provided by the second cell.

In one aspect, a method implemented in a or by a UE for selecting cell search can include several actions. These can include: acquiring by the UE a first RAN cell using a first search window associated with the first RAN cell; determining to acquire a second RAN cell operating at least in part in the same region as the first RAN cell; selecting a second search window for acquiring the second RAN cell, wherein the second search window is different from the first search window; and acquiring the second RAN cell using the selected second search window. In one aspect, selecting a second search window for acquiring the second RAN cell further includes: determining if a pilot spacing parameter for the second RAN cell is known to the UE; if the pilot spacing parameter is known, computing the second search window size as a function of the pilot spacing parameter; and if the pilot spacing parameter is unknown, selecting a default value for the second search window size. In another aspect, acquiring the second RAN cell using the selected second search window further comprises searching in the second search window the pilot signal from the second RAN cell. Yet in another aspect, after acquiring the second RAN cell using the default value for the second search window size, the method further includes: receiving from the second RAN cell the pilot spacing parameter for the second RAN cell; computing the second search window size as a function of the received pilot spacing parameter; and storing in a memory of the UE the received pilot spacing parameter and computed second search window size for the second RAN cell.

In another aspect, a UE configured to implement the above-described method for selecting cell search window may include: a memory for storing search window parameters for a plurality of RAN cells; a receiver operable to receive pilot signals from a plurality of RAN cells; and a processor coupled to the memory and to the receiver and operable to: acquire a first RAN cell using a first search window associated with the first RAN cell; determine to acquire a second RAN cell operating at least in part in the same region as the first RAN cell; select a second search window for acquiring the second RAN cell, wherein the second search window is different from the first search window; and acquire the second RAN cell using the selected second search window.

The above presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is an illustration of a wireless communication system for implementing methodology for dynamically configuring cell search window for pilot acquisition in accordance with aspects disclosed herein.

FIG. 2 is an illustration of an example methodology for pilot acquisition according to some embodiments of the present invention.

FIG. 3 is an illustration of an example pilot signal spacing according to some embodiments of the present invention.

FIG. 4 is an illustration of a dynamically configured cell search window for pilot acquisition in accordance with aspects disclosed herein.

FIG. 5 is an illustration of a methodology for dynamically configuring cell search window for pilot acquisition in accordance with aspects disclosed herein.

FIG. 6 is an illustration of an example wireless communication system in accordance with one aspect.

FIG. 7 is an illustration of a mobile device that implements methodology for dynamically configuring cell search window for pilot acquisition in accordance with aspects disclosed herein.

FIG. 8 is an illustration of an example communication apparatus in accordance with one aspect.

### DETAILED DESCRIPTION

The following detailed description and the annexed drawings set forth in detail certain illustrative features of the one or more aspects of system, methods and computer program products for dynamically configuring cell search window for pilot acquisition. These features are indicative, however, of but a few of the various ways in which the principles of various aspects may be employed, and this description is intended to include all such aspects and their equivalents. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

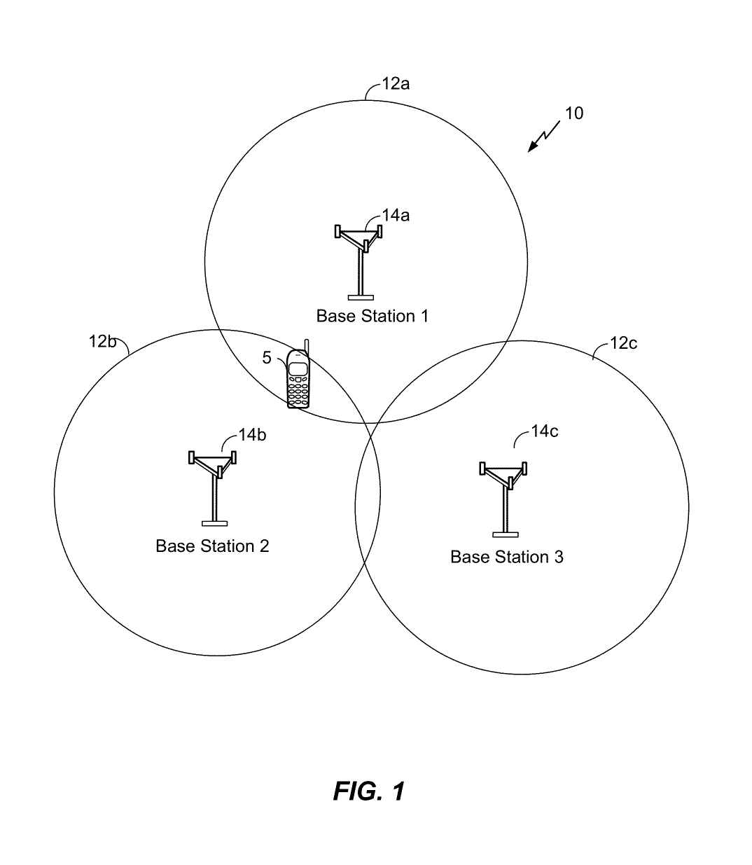

FIG. 1 is a diagram of a wireless communication system 10 that includes a number of base stations and supports a number of mobile devices (also referred herein as UEs). System 10 includes a number of base stations 14a, 14b, 14c (although the number of base stations may be unlimited, only three base stations are shown in FIG. 1 for simplicity), with each base station serving a particular coverage area 12a, 12b or 12c. The base station 14 and its coverage area 12 are often collectively referred to as a cell. A large number of mobile devices 5 are typically dispersed throughout the system (only one device is shown in FIG. 1 for simplicity).

Each mobile device 5 may communicate with one or more base stations on the forward and reverse links at any moment in the active mode. In the example shown in FIG. 1, base station 1 is the preferred base station (which is also often referred to as the serving cell) for mobile device 5, and base stations 2 and 3 are the neighboring base stations of base station 1. The serving base station is generally the base station whose signal is received the strongest by the mobile device 5. The mobile device is typically expected to receive its paging information from the base station with the strongest signal, and therefore from the serving base station.

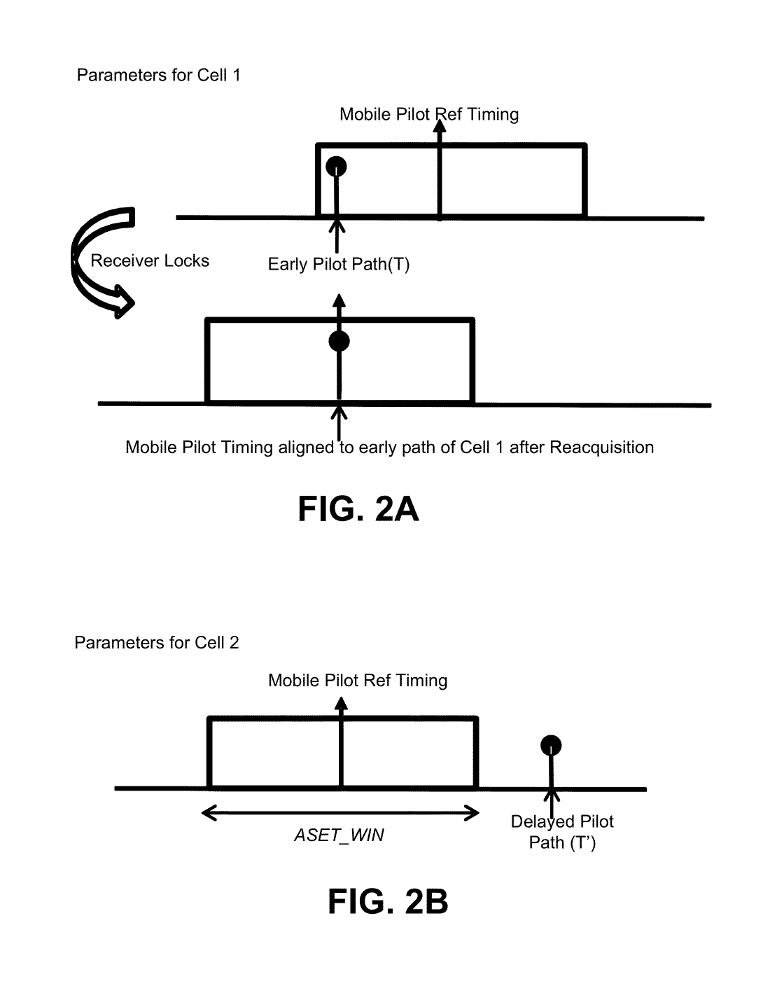

As shown in FIG. 1, mobile device 5 is located in the overlap region within coverage of two or more neighboring cells 1 and 2. In this region, the mobile device 5 may see strong signal paths from both cells 1 and 2. In a scenario where first arriving pilot path from serving cell 1 is the ‘early’ path, the RAKE receiver of the mobile device 5 will lock to the ‘early path’ of cell 1 using search parameters of cell 1. This process shown in FIG. 2A. However, due to, for example, overload in cell 1 or as per standard recommendation, cell 1 may instruct the mobile device 5 to try to switch (or handoff) to a neighbor cell 2 or different sector of cell 1. If the first arriving path from cell 2 is a delayed pilot path, the presently configured active search window parameter (ASET_WIN) for cell 1 may not be sufficient to lock on to the cell 2, due to the large difference in timings of the two cells. This scenario is shown in FIG. 2B. This forces the mobile device 5 to go back and try to reacquire cell 1, but cell 1 may again redirect the mobile device to reacquire cell 2 and this process repeats. This ping-pong effect causes a system loss as the mobile device 5 does not get locked to any of these cells.

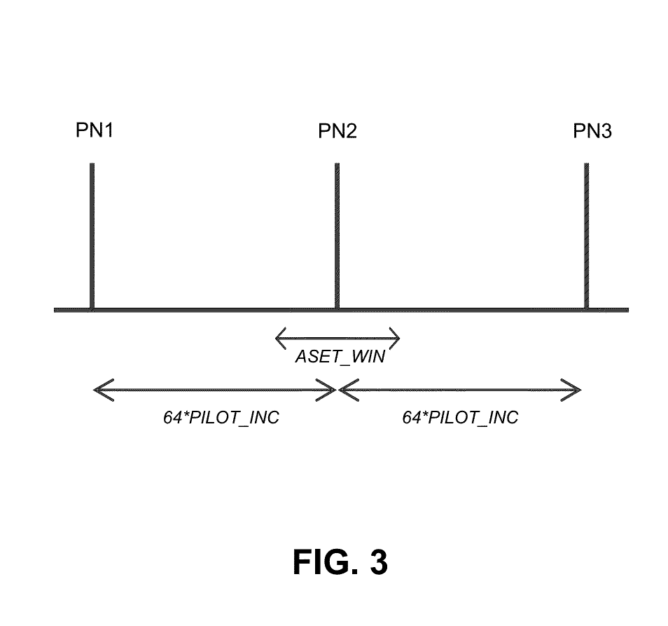

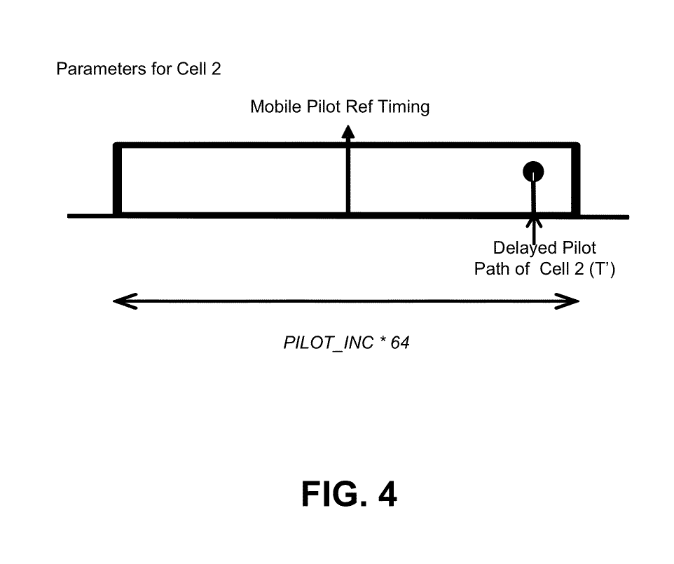

Accordingly, in one aspect, the mobile device 5 may be configured to dynamically reset its search parameters, such as the search window size, to acquire time shifted multipath component(s) of the pilot signal from the neighboring cell(s) during soft/hard handoff, channel hashing, or channel redirection scenarios. As shown in FIG. 3, spacing between pilot signals from neighboring cells PN1, PN2, and PN3 for same frequency X (REF_PN=PN 2 in this case) is typically equal to “PILOT_INC*64 chips”, wherein PILOT_INC is a pilot spacing parameter provided by the base station. Value of the PILOT_INC parameter is typically configured by the RAN based on, for example, the geographical terrain where the cell is located and may include an integer in the range of 1 to 4 according to one example aspect. For example, the value of PILOT_INC can be set larger in urban environments to mitigate strong effects of multipath, and set smaller in rural environments where multipath is not as strong. However, the value of search window is typically fixed by the RAN to ASET_WIN value. It has been observed that in a typical WCDMA system the drift in pilot timing varies in the range of REF_PN±(PILOT_INC/2), so that Max_drift=REF_PN+(PILOT_INC/2), Min_drift=REF_PN−(PILOT_INC/2) and Range of Drift=(REF_PN+(PILOT_INC/2))−(REF_PN−(PILOT_INC/2))=PILOT_INC. Therefore, the maximum range in which the pilot can drift from its reference position is PILOT_INC and the drift size is PILOT_INC*64 chips. Accordingly, in one aspect, the mobile device 5 may dynamically set its search window to the size of total drift PILOT_INC*64 to acquire the pilot timings from neighboring cell (e.g., cell 2), as shown in FIG. 4.

More specifically, if the mobile device 5 knows value of PILOT_INC parameter provided by the target cell 2, the mobile device 5 may dynamically adjust the size of its search window to PILOT_INC*64 chips when the mobile device 5 tries to acquire a pilot signal from cell 2. And in cases where the PILOT_INC value is unknown, size of the window may be set to a default value, such as 4×64 chips or another value. Once the receiver of the mobile device 5 locks to cell 2 successfully, the search parameters can be reset again based on the values provided by cell 2. This window size will be large enough to capture pilot signal peaks from cell 2. The dynamic values of search window will enable the mobile device 5 to lock to the delayed multipath signal components from cell 2, which may be outside the delay range provided by the search window of cell 1. This approach for dynamic selection of search parameters will prevent call drops and system losses in many problem scenarios. In one aspect, window size should not be set to a value larger than the max drift value PILOT_INC*64 chips as it may attract false peak detections, so a tradeoff between window size and timing delay of a cell is required.

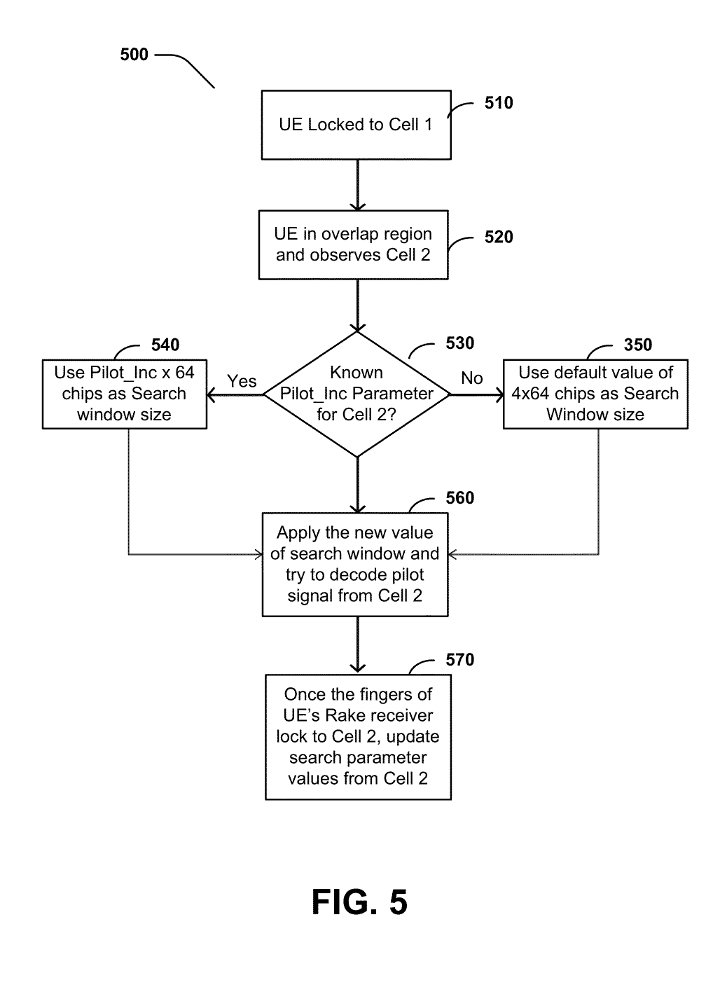

FIG. 5 is illustrates an example methodology 500 for dynamically setting search parameters of a mobile device (e.g., mobile device 5). At step 510, the mobile device locks to cell 1 and configures its receiver parameters, including search window parameters, to those provided by cell 1. At step 520, the mobile device moves into an overlap region between cells 1 and 2 and tries to acquire Pilot Signal from cell 2. Particularly, at step 530, the mobile device checks if the value of pilot spacing parameter (PILOT_INC) for cell 2 is stored in the device's memory, for example, in the active set information. If the value of PILOT_INC for cell 2 is known, then at step 540, the mobile devices sets the size of its Search window to PILOT_INC*64 chips. If the value of PILOT_INC for cell 2 is unknown, then at step 550, the mobile device sets the size of its Search window to a default value, e.g., 4*64 chips. Then, at step 560, the mobile device applies new search window values to the searcher module of the Rake and tries to decode pilot signal from cell 2 using Rake receiver. Once fingers of the Rake receiver lock to cell 2, at step 570, the mobile devices obtains and updates search parameter values from cell 2.

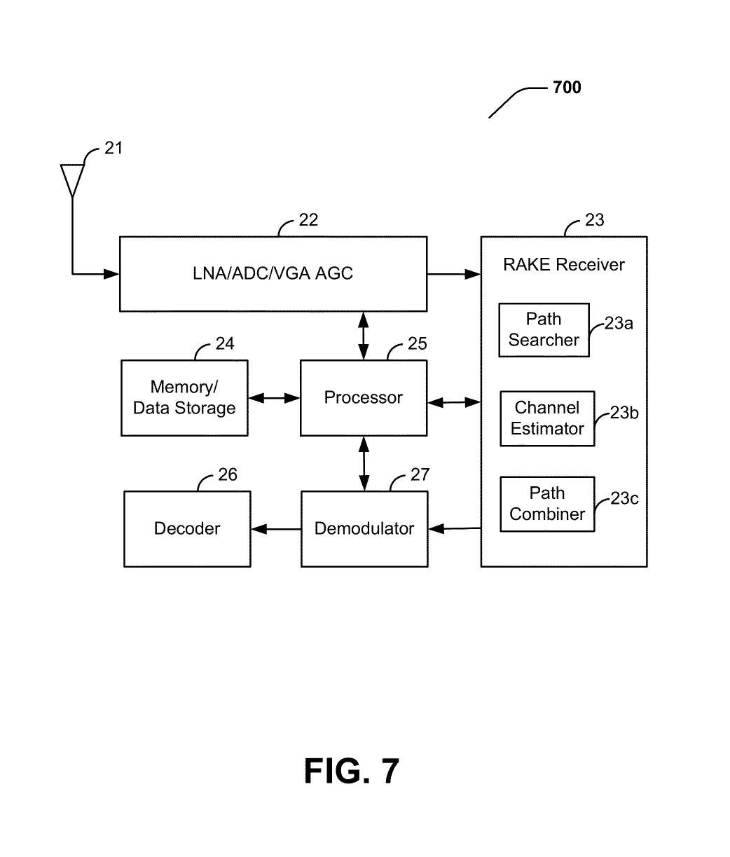

FIG. 7 illustrates an example configuration of a mobile device operable to dynamically set its cell search parameters using methodology of FIG. 5. Mobile device 700 includes a RF antenna 21 that receives RF signals, such as pilot signals, from base stations and transforms them into electromagnetic signals. The signals are transmitted to amplifier circuit 22, which may include a low noise amplifier (LNA), analog-to-digital converter (ADC), variable gain amplifier (VGA) and automatic gain control (AGC) circuit, which calibrates operating range of the LNA, ADC and VGA. The amplified and digitized signals are then passed to Rake receiver 23, which is designed to mitigate the effects of multipath fading. Rake receiver 23 includes a path search 23a, which identifies different propagation paths of the signal, a channel estimator 23b, which estimates channel conditions, such as time delay, amplitude and phase for each path component, and a path combiner 23c, which combines strongest multipath components of the received signal into one signal. The resulting signal is then demodulated by demodulator 27 and decoded by decoder 26. Processor 25, which could be any general purpose processor, contains operational logic for controlling operation of the components of the mobile device 700. In one aspect, the processor 25 includes operation logic for implementing algorithm, disclosed above with referenced to FIG. 5, for dynamically selecting search window for path searcher 23a of the receiver 23. Memory/data storage 24 stores various operational settings and parameters of the components of the receiver 23, such as synchronization information, including frequency and timing parameters, such as search window size PILOT_INC parameters for various base stations.

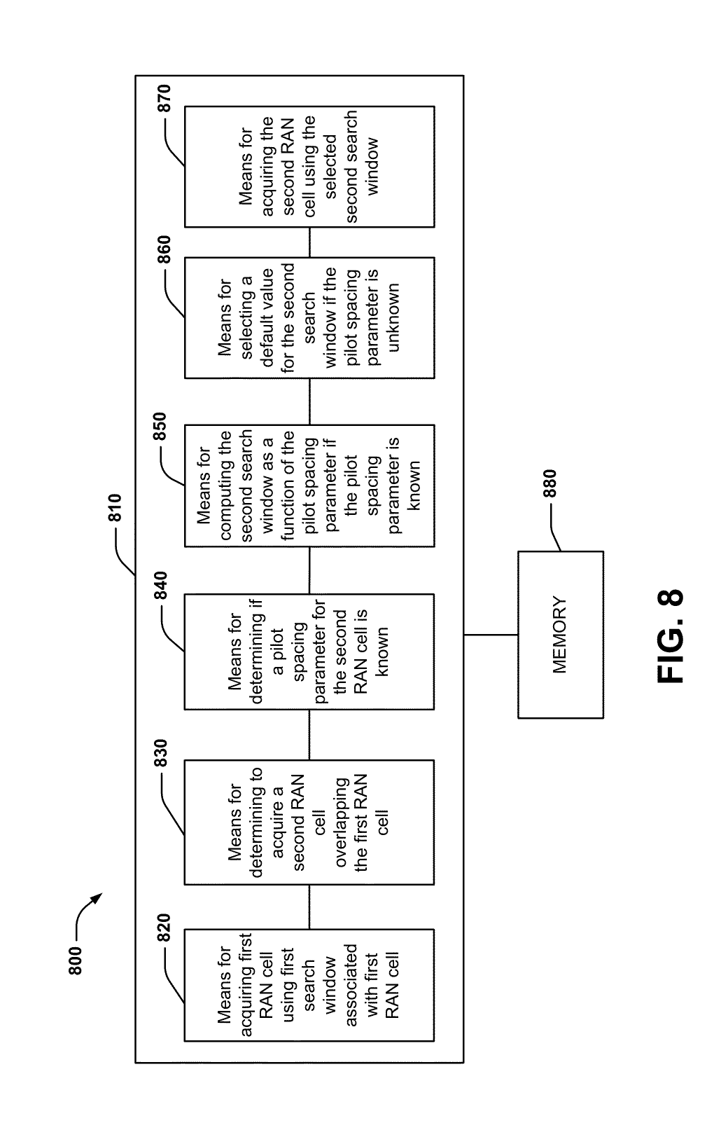

FIG. 8 illustrates an example configuration of a communication apparatus in accordance with one aspect. As depicted, apparatus 800 includes functional blocks that can represent functions implemented by a processor, software, or combination thereof (e.g., firmware). Apparatus 800 includes a logical grouping 810 of electrical components that facilitate execution of algorithms for dynamic selection of cell search window for a mobile device. Logical grouping 810 can include means 820 for acquiring a first RAN cell using first search window associated with the first RAN cell. Logical grouping 810 can include means 830 for determining to acquire a second RAN cell overlapping the first RAN cell. Moreover, logical grouping 810 can include means 840 for determining if a pilot spacing parameter (PILOT_INC) for the second RAN cell is known. Furthermore, logical grouping 810 can include means 850 for computing the second search window as a function of the pilot spacing parameter (PILOT_INC*64) if the pilot spacing parameter is known. In addition, logical grouping 810 can include means 860 for selecting a default value for the second search window if the pilot spacing parameter is unknown. Moreover, logical grouping 810 can include means 870 for acquiring the second RAN cell using the selected second search window. Additionally, apparatus 800 can include a memory 880 that retains instructions for executing functions associated with electrical components 820 to 870. While shown as being external to memory 880, it is to be understood that electrical components 820 to 870 can exist within memory 880.

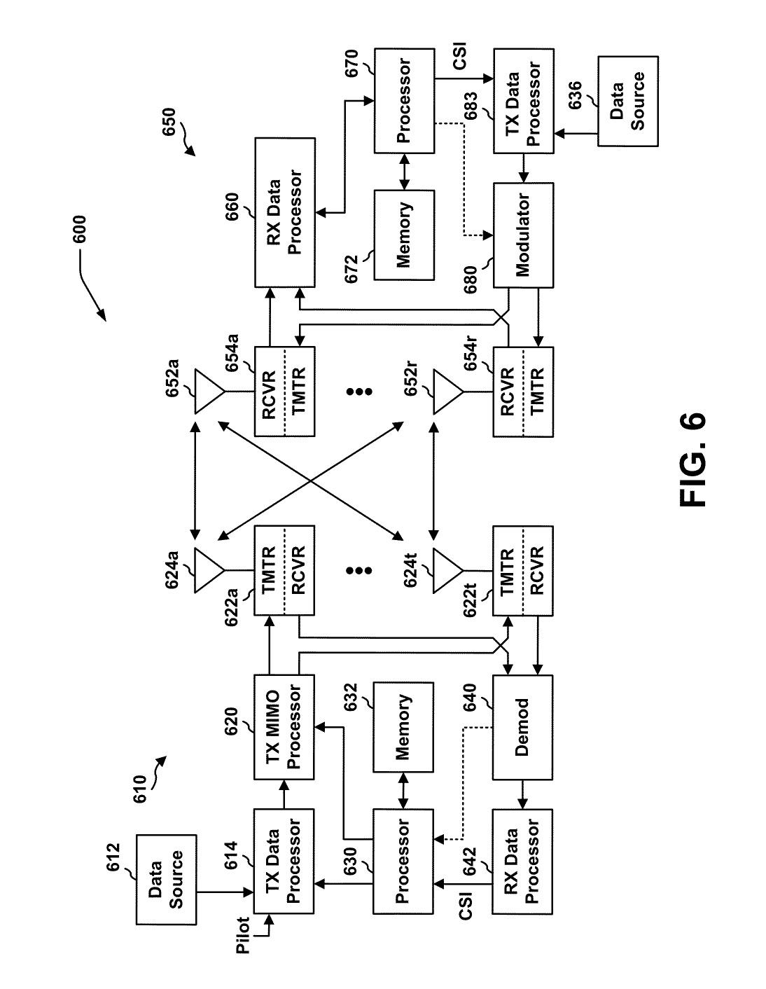

FIG. 6 shows an example of a wireless communication system 600 in which various aspects of the methodologies for dynamically configuring cell search window for pilot acquisition may be implemented. The system 600 depicts one base station/forward link transmitter 610 in a radio access network and one mobile device 650 for sake of brevity. However, it is to be appreciated that system 600 can include more than one base station/forward link transmitter and/or more than one mobile device, wherein additional base stations/transmitters and/or mobile devices can be substantially similar or different from example base station/forward link transmitters 610 and mobile device 650 described below. In addition, it is to be appreciated that base station/forward link transmitter 610 and/or mobile device 650 can employ the system (FIG. 7) and/or method (FIG. 5) described herein to facilitate dynamic configuring of cell search window.

At base station/forward link transmitter 610, traffic data for a number of data streams is provided from a data source 612 to a transmit (TX) data processor 614. According to an example, each data stream can be transmitted over a respective antenna. TX data processor 614 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 650 to estimate channel response. The multiplexed pilot and coded data for each data stream can be modulated (e.g., symbol mapped) based on a particular modulation scheme (e.g., binary phase-shift keying (BPS K), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 630.

Modulation symbols for the data streams can be provided to a TX MIMO processor 620, which can further process the modulation symbols (e.g., for OFDM). TX MIMO processor 620 then provides NT modulation symbol streams to NT transmitters (TMTR) 622a through 622t. In various aspects, TX MIMO processor 620 applies beamforming weights to the symbols of the data streams and to the antenna from which the symbol is being transmitted.

Each transmitter 622 receives and processes a respective symbol stream to provide one or more analog signals, and further conditions (e.g., amplifies, filters, and upconverts) the analog signals to provide a modulated signal suitable for transmission over the MIMO channel. Further, NT modulated signals from transmitters 622a through 622t are transmitted from NT antennas 624a through 624t, respectively.

At mobile device 650, the transmitted modulated signals are received by NR antennas 652a through 652r and the received signal from each antenna 652 is provided to a respective receiver (RCVR) 654a through 654r. Each receiver 654 conditions (e.g., filters, amplifies, and downconverts) a respective signal, digitizes the conditioned signal to provide samples, and further processes the samples to provide a corresponding “received” symbol stream.

An RX data processor 660 can receive and process the NR received symbol streams from NR receivers 654 based on a particular receiver processing technique to provide NT “detected” symbol streams. RX data processor 660 can demodulate, deinterleave, and decode each detected symbol stream to recover the traffic data for the data stream. The processing by RX data processor 660 is complementary to that performed by TX MIMO processor 620 and TX data processor 614 at base station/forward link transmitter 610.

A processor 670 can periodically determine which precoding matrix to utilize as discussed above. Further, processor 670 can formulate a reverse link message comprising a matrix index portion and a rank value portion.

The reverse link message can comprise various types of information regarding the communication link and/or the received data stream. The reverse link message can be processed by a TX data processor 638, which also receives traffic data for a number of data streams from a data source 636, modulated by a modulator 680, conditioned by transmitters 654a through 654r, and transmitted back to base station/forward link transmitter 610.

At base station/forward link transmitter 610, the modulated signals from mobile device 650 can be received by antennas 624, conditioned by receivers 622, demodulated by a demodulator 640, and processed by a RX data processor 642 to extract the reverse link message transmitted by mobile device 650. Further, processor 630 can process the extracted message to determine which precoding matrix to use for determining the beamforming weights. It is to be appreciated that in the case of a forward link transmitter 810, as opposed to a base station, these RX components may not be present since data is only broadcasted over the forward link.

Processors 630 and 670 can direct (e.g., control, coordinate, manage, etc.) operation at base station/forward link transmitter 610 and mobile device 650, respectively. Respective processors 630 and 670 can be associated with memory 632 and 672 that store program codes and data. Processors 630 and 670 can also perform computations to derive frequency and impulse response estimates for the uplink and downlink, respectively.

It is to be understood that the aspects described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the aspects are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means known in the art.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects, it should be noted that various changes and modifications could be made herein without departing from the scope of the described aspects as defined by the appended claims. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise.

We claim:

1. A method for selecting cell search window for a mobile device, the method comprising:
acquiring by the mobile device a first radio access network (RAN) cell using a first search window associated with the first RAN cell;
determining to acquire a second RAN cell operating at least in part in the same region as the first RAN cell;
selecting a second search window for acquiring the second RAN cell, wherein the second search window is different from the first search window; and
acquiring the second RAN cell using the selected second search window.

2. The method of claim 1, wherein selecting a second search window for acquiring the second RAN cell further comprises:
determining if a pilot spacing parameter for the second RAN cell is known to the mobile device;
if the pilot spacing parameter is known, computing the second search window size as a function of the pilot spacing parameter; and
if the pilot spacing parameter is unknown, selecting a default value for the second search window size.

3. The method of claim 2, wherein acquiring the second RAN cell using the selected second search window further comprises:
searching in the second search window the pilot signal from the second RAN cell.

4. The method of claim 2, wherein, after acquiring the second RAN cell using the default value for the second search window size,
receiving from the second RAN cell the pilot spacing parameter for the second RAN cell, and
computing the second search window size as a function of the received pilot spacing parameter; and
storing in a memory of the mobile device the received pilot spacing parameter and computed second search window size for the second RAN cell.

5. The method of claim 2, wherein the pilot spacing parameter is PILOT_INC parameter.

6. The method of claim 5, wherein the second search window is computed as PILOT_INC*64 chips.

7. An apparatus for selecting cell search window for a mobile device, the apparatus comprising:
a memory for storing search window parameters for a plurality of radio access network (RAN) cells;
a receiver operable to receive pilot signals from a plurality of RAN cells; and
a processor coupled to the memory and to the receiver and operable to:
acquire a first RAN cell using a first search window associated with the first RAN cell;
determine to acquire a second RAN cell operating at least in part in the same region as the first RAN cell;
select a second search window for acquiring the second RAN cell, wherein the second search window is different from the first search window; and
acquire the second RAN cell using the selected second search window.

8. The apparatus of claim 7, wherein to select a second search window for acquiring the second RAN cell, the processor is further operable to:
determine if a pilot spacing parameter for the second RAN cell is known to the mobile device;
if the pilot spacing parameter is known, compute the second search window size as a function of the pilot spacing parameter; and
if the pilot spacing parameter is unknown, select a default value for the second search window size.

9. The apparatus of claim 8, wherein to acquire the second RAN cell using the selected second search window, the processor is further operable to:
search in the second search window the pilot signal from the second RAN cell.

10. The apparatus of claim 8, wherein, after acquiring the second RAN cell using the default value for the second search window size, the processor is further operable to:
receive from the second RAN cell the pilot spacing parameter for the second RAN cell, and
compute the second search window size as a function of the received pilot spacing parameter; and
store in the memory the received pilot spacing parameter and computed second search window size for the second RAN cell.

11. The apparatus of claim 8, wherein the pilot spacing parameter is PILOT_INC parameter.

12. The apparatus of claim 11, wherein the second search window is computed as PILOT_INC*64 chips.

13. A computer program product for selecting cell search window for a mobile device, the product comprising a non-transitory computer-readable medium comprising:
a first set of codes for acquiring by the mobile device a first radio access network (RAN) cell using a first search window associated with the first RAN cell;
a second set of codes for determining to acquire a second RAN cell operating at least in part in the same region as the first RAN cell;
a third set of codes for selecting a second search window for acquiring the second RAN cell, wherein the second search window is different from the first search window; and
a fourth set of codes for acquiring the second RAN cell using the selected second search window.

14. The product of claim 13, wherein the third set of codes for selecting a second search window for acquiring the second RAN cell, further includes:
a fifth set of codes for determining if a pilot spacing parameter for the second RAN cell is known to the mobile device;
a sixth set of codes for, if the pilot spacing parameter is known, computing the second search window size as a function of the pilot spacing parameter; and
a seventh set of codes for, if the pilot spacing parameter is unknown, selecting a default value for the second search window size.

15. The product of claim 14, wherein the fourth set of codes for acquiring the second RAN cell using the selected second search window, further includes:
a ninth set of codes for searching in the second search window the pilot signal from the second RAN cell.

16. The product of claim 14, wherein, after acquiring the second RAN cell using the default value for the second search window size, further includes:
a tenth set of codes for receiving from the second RAN cell the pilot spacing parameter for the second RAN cell, and
an eleventh set of codes for computing the second search window size as a function of the received pilot spacing parameter; and
a twelfth set of codes for storing in a memory of the mobile device the received pilot spacing parameter and computed second search window size for the second RAN cell.

17. The product of claim 14, wherein the pilot spacing parameter is PILOT_INC parameter.

18. The product of claim 17, wherein the second search window is computed as PILOT_INC*64 chips.

19. An apparatus for establishing connection with a radio access network, the apparatus comprising:
means for acquiring by the mobile device a first radio access network (RAN) cell using a first search window associated with the first RAN cell;
means for determining to acquire a second RAN cell operating at least in part in the same region as the first RAN cell;
means for selecting a second search window for acquiring the second RAN cell, wherein the second search window is different from the first search window; and
means for acquiring the second RAN cell using the selected second search window.

20. The apparatus of claim 19, wherein means for selecting a second search window for acquiring the second RAN cell further comprises:
means for determining if a pilot spacing parameter for the second RAN cell is known to the mobile device;
means for, if the pilot spacing parameter is known, computing the second search window size as a function of the pilot spacing parameter; and
means for, if the pilot spacing parameter is unknown, selecting a default value for the second search window size.

21. The apparatus of claim 20, wherein means for acquiring the second RAN cell using the selected second search window further comprises:
means for searching in the second search window the pilot signal from the second RAN cell.

22. The apparatus of claim 20, wherein, after acquiring the second RAN cell using the default value for the second search window size, further comprises:
means for receiving from the second RAN cell the pilot spacing parameter for the second RAN cell, and
means for computing the second search window size as a function of the received pilot spacing parameter; and
means for storing in a memory of the mobile device the received pilot spacing parameter and computed second search window size for the second RAN cell.

23. The apparatus of claim 20, wherein the pilot spacing parameter is PILOT_INC parameter.

24. The apparatus of claim 23, wherein the second search window is computed as PILOT_INC*64 chips.

25. A wireless communication device configured to communicate in a wireless communication network, the device comprising:
a communications interface configured to connect to a first network using a first search window associated with the first network;
a processor configured to determine to connect to a second network that at least in part overlaps with the first network;
the processor configured to select a second search window for acquiring the second network; and
the communications interface configured to connect to the second network using the second search window.

26. The device of claim 25, wherein the processor is further configured to:
determine if a pilot spacing parameter for the second network is known;
if the pilot spacing parameter is known, compute the second search window as a function of the pilot spacing parameter; and
if the pilot spacing parameter is unknown, selecting a default value for the second search window.

27. The device of claim 25, wherein the communications interface comprises a transceiver.

28. The device of claim 25, wherein the processor is further configured to dynamically select another network based on the processor being able to determine that it cannot communicate with at least one of the first or second network.

29. The device of claim 25, wherein the first search window and the second search window have varying window sizes.

30. The device of claim 25, the processor can be further configured to:
compute the second search window size as a function of a received pilot spacing parameter associated with the second network; and
store the pilot spacing parameter and the second search window size for the second network.
